(19) United States
(12) Patent Application Publication
(10) Pub. No.: US 2016/0043472 A1
(43) Pub. Date: Feb. 11, 2016

(54) MONOCONE ANTENNA

(71) Applicant: TYCO ELECTRONICS CORPORATION, Berwyn, PA (US)

(72) Inventors: Kathleen Fasenfest, Union City, CA (US); Nahid Rahman, Santa Clara, CA (US)

(21) Appl. No.: 14/886,879

(22) Filed: Oct. 19, 2015

Related U.S. Application Data
(63) Continuation-in-part of application No. 14/263,563, filed on Apr. 28, 2014.

(51) Int. Cl. H01Q 13/02

(52) U.S. Cl. CPC H01Q 13/02

(57) ABSTRACT

A monocone antenna includes a volumetric radiation element having a feed point at a vertex of the volumetric radiation element being connected to a feed transmission line and a capacitive ring radially outside of the volumetric radiation element and in proximity to the volumetric radiation element. The capacitive ring is connected to a ground plane for the monocone antenna.

### CROSS REFERENCE TO RELATED APPLICATIONS

This application is a continuation-in-part application of U.S. patent application Ser. No. 14/263,563 filed Apr. 28, 2014, titled MONOCONE ANTENNA, the subject matter of which is herein incorporated by reference in its entirety.

### BACKGROUND OF THE INVENTION

The subject matter disclosed herein relates generally to communication antennas and identification antennas, such as for vehicular installations.

Antennas are used for transmitting and receiving electromagnetic radiation for communication applications, identifications applications, and the like. Some antennas use vertically polarized antennas to efficiently transmit and receive vertically polarized signals. For example, vertical polarization is commonly used for aircraft communications and identification applications. Monopole and monocone antennas are types of vertically polarized antennas. For a typical monopole or monocone installation, the antenna is one quarter wavelength in height above the mounting surface, such as above the aircraft surface. The antenna creates aerodynamic drag and the antennas can easily be damaged due to their protrusion above the surface. Merely shortening the antenna increases the inductance of the antenna, which detrimentally affects the performance of the antenna. A need remains for a conformal vertically-polarized antenna for particular applications, such as installation on airborne platforms including commercial, military and general aviation platforms as well as marine, automotive, and other applications.

### BRIEF DESCRIPTION OF THE INVENTION

In one embodiment, a monocone antenna is provided including a volumetric radiation element having a feed point at a vertex of the volumetric radiation element being connected to a feed transmission line and a capacitive ring radially outside of the volumetric radiation element and in proximity to the volumetric radiation element. The capacitive ring is connected to a ground plane for the monocone antenna.

Optionally, the monocone antenna may include a capacitive gap between the volumetric radiation element and the capacitive ring, which may be substantially filled with dielectric material. The volumetric radiation element may extend vertically between an open top and the vertex of the volumetric radiation element. The capacitive ring may extend vertically from a top to a bottom, with the top of the capacitive ring being generally coplanar with the top of the volumetric radiation element and with the bottom of the capacitive ring being vertically aligned with or vertically below the vertex. Optionally, the vertex of the volumetric radiation element may be the bottom-most area of the volumetric radiation element.

Optionally, the monocone antenna may include a substrate having an inner cavity wall defining a cavity open at a top of the substrate. The volumetric radiation element may be located on the inner cavity wall of the substrate. The capacitive ring may be positioned radially outside of the inner cavity wall. The capacitive ring may be positioned on an exterior of the substrate. Optionally, a width of the substrate between the inner cavity wall and corresponding volumetric radiation element and the exterior and corresponding capacitive ring may be variable along a height of the substrate.

Optionally, the inner cavity wall may be defined by a spline of revolution. The spline of revolution may be linear between the top and the vertex. The spline of revolution may be curved between the top and the vertex. Optionally, the inner cavity wall may have a right circular conical shape. The inner cavity wall may have an oblique conical shape. The inner cavity wall may have an elliptic conical shape. The inner cavity wall may have an elliptic parabolic shape.

Optionally, the monocone antenna may include a substrate having a base, a top and a side wall between the base and the top. The substrate may have a cavity with the volumetric radiation element positioned in the cavity. The capacitive ring may be positioned on the side wall. Optionally, the volumetric radiation element may be deposited directly on an inner cavity wall of the substrate defining the cavity. The capacitive ring may be positioned on at least one of the top and the base. The substrate may define a capacitive gap between the capacitive ring and the volumetric radiation element.

Optionally, the volumetric radiation element may include a nested protrusion at the vertex. The nested protrusion may be connected to the feed point. The volumetric radiation element may include an outer segment radially outward of the nested protrusion. The outer segment may be inwardly and downwardly tapered. The nested protrusion may be inwardly and upwardly tapered.

Optionally, the volumetric radiation element may be defined by a spline of revolution. The spline of revolution may have a spline extending from a top of the monocone antenna to the vertex. The spline may be rotated about the feed point to define the spline of revolution. The spline may be linear. The spline may have at least one downward component at a radially outer end of the spline and at least one upward component radially inside the radially outer end.

### BRIEF DESCRIPTION OF THE DRAWINGS

FIG. 1 is a top perspective view of a monocone antenna formed in accordance with an exemplary embodiment.

FIG. 2 is a side view of the monocone antenna.

FIG. 3 is a bottom view of the monocone antenna.

FIG. 4 is a top perspective view of the monocone antenna with a radome.

FIG. 5 is a side view of the monocone antenna and radome.

FIG. 6 is a side view of the monocone antenna in accordance with an exemplary embodiment.

FIG. 7 is a top perspective view of the monocone antenna in accordance with an exemplary embodiment.

FIG. 8 is a top perspective view of a monocone antenna formed in accordance with an exemplary embodiment.

FIG. 9 is a cross-sectional view of the monocone antenna shown in FIG. 8.

FIG. 10 is a top perspective view of the monocone antenna shown in FIG. 8 showing a radome.

FIG. 11 is a top perspective view of the monocone antenna formed in accordance with an exemplary embodiment.

FIG. 12 is a cross-sectional view of the monocone antenna shown in FIG. 11.

FIG. 13 is another cross-sectional view of the monocone antenna shown in FIG. 11.

### DETAILED DESCRIPTION OF THE INVENTION

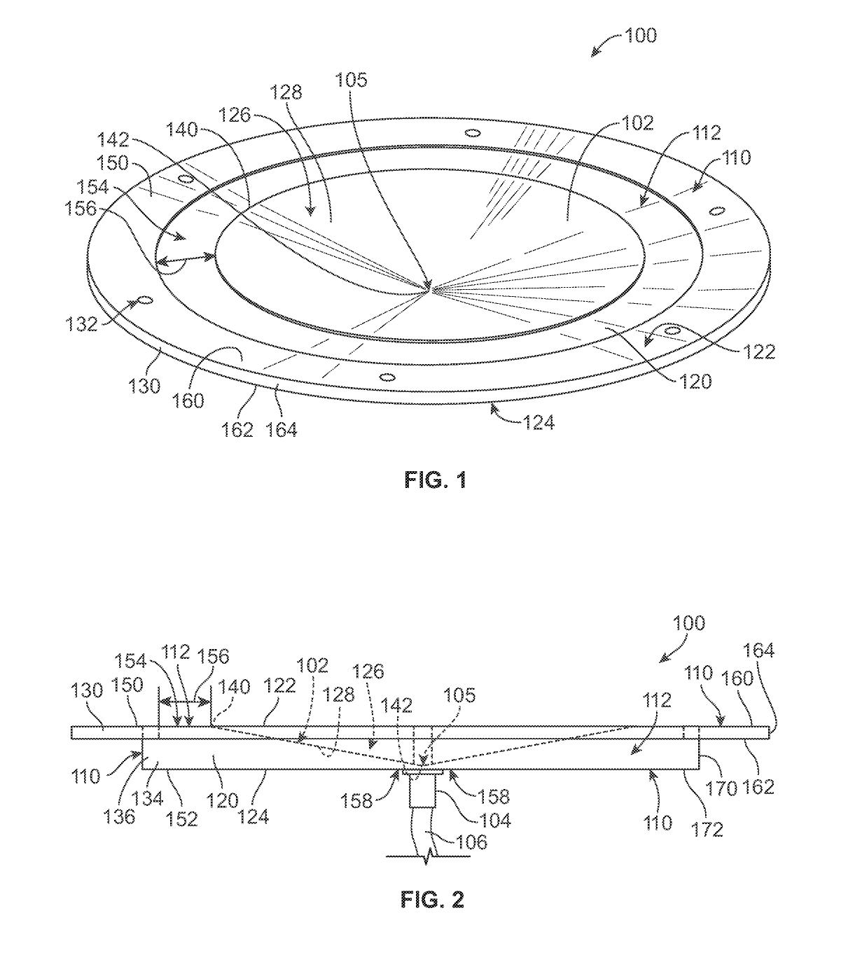

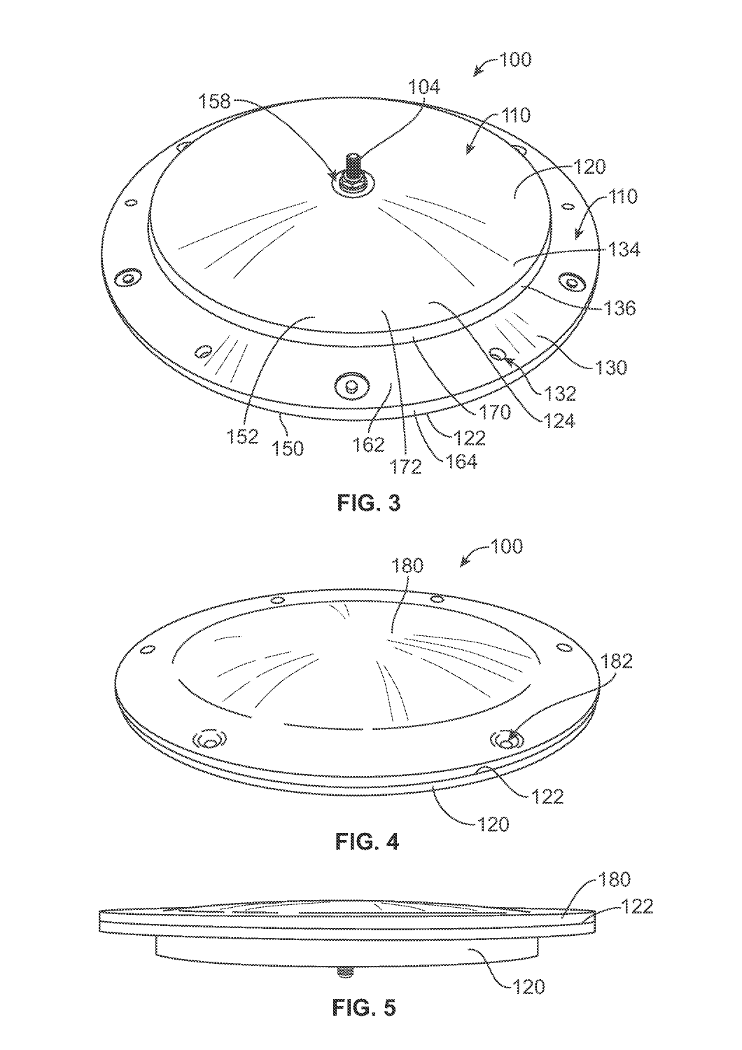

FIG. 1 is a top perspective view of a monocone antenna 100 formed in accordance with an exemplary embodiment. FIG. 2 is a side view of the monocone antenna 100. FIG. 3 is a bottom view of the monocone antenna 100.

The monocone antenna 100 may be either a radiator or receiver of electromagnetic signals, such as radio frequency (RF) signals. In an exemplary embodiment, the monocone antenna 100 is a conformal antenna for installation on an airborne platform, such as a commercial, military, or general aviation platform. The conformal antenna 100 may be used as a communication antenna and/or an identification antenna for an airborne vehicle. The monocone antenna 100 has a very low profile to reduce or eliminate aerodynamic drag and potential for damage. Optionally, the monocone antenna 100 may be embedded in a surface of the aircraft such that the monocone antenna 100 has little or no protrusion above the airframe. The monocone antenna 100 is designed to be electrically short to increase its conformity. In an exemplary embodiment, the monocone antenna is less than one-tenth of a free space wavelength in height.

The monocone antenna 100 includes a radiation element 102 that defines a radiator of the monocone antenna 100. The radiation element 102 may be generally conical in shape defining a concave area inside the radiation element 102. The radiation element 102 has a feed point 104 at a vertex 105 of the radiation element 102. The feed point 104 is configured to be connected to a feed transmission line 106 (shown in FIG. 2), which may be a cable or other type of feed transmission line. The feed point 104 may be an RF connector, such as a sub-miniature type A (SMA) connector.

The monocone antenna 100 includes a capacitive ring 110 radially outside of the radiation element 102 and in proximity to the radiation element 102. The capacitive ring 110 is configured to be connected to a ground plane for the monocone antenna 100. The capacitive ring 110 is designed for impedance matching. The capacitive ring 110 adds capacitance to the monocone antenna 100 and lowers inductance of the radiation element 102. The radiation element 102 is electrically shortened, such as to a height less than one-quarter wavelength, to increase its conformity. Optionally, the radiation element 102 may be less than one-tenth of a free space wavelength in height. The capacitive ring 110 mitigates the added inductance due to the electrically short radiation element 102. The monocone antenna 100 is a very short, vertically polarized antenna which may be installed on an aircraft surface or recessed into the aircraft surface to reduce aerodynamic drag and potential for damage by limiting protrusion or height above the aircraft surface.

A capacitive gap 112 is defined between the radiation element 102 and the capacitive ring 110. The capacitive gap 112 is substantially filled with dielectric material. The dielectric material may be a plastic material. The dielectric material may be air. The size of the capacitive gap 112 controls the spacing between the radiation element 102 and the capacitive ring 110. The size of the capacitive gap 112 is designed for impedance matching. The spacing between the radiation element 102 and the capacitive ring 110 controls the added capacitance therebetween for impedance matching.

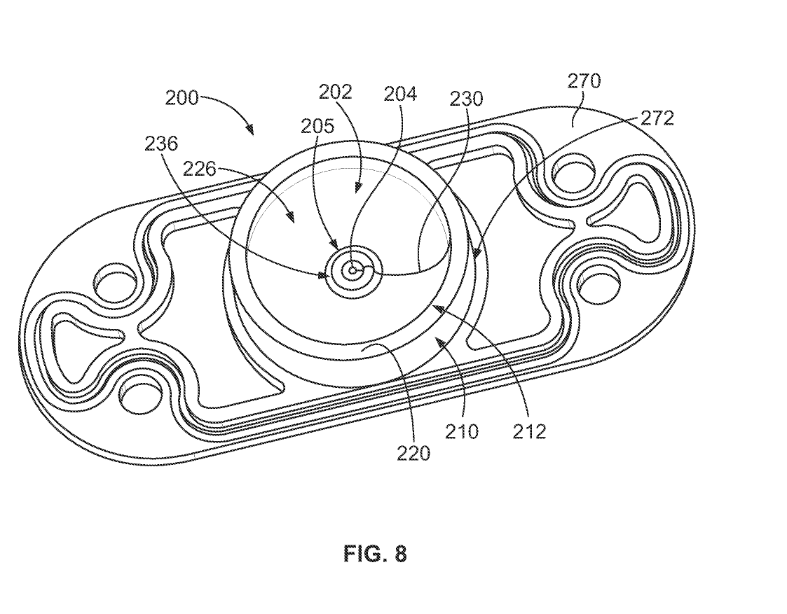

The monocone antenna 100 may be constructed of one or more conductors defining the radiation element 102. The conductor or conductors forming the radiation element 102 may be solid or may be partially solid, such as an array of conductors disposed conically about the common feed point 104. The conductor or conductors forming the radiation element 102 may be a surface or may be a wire grid, such as one or more wires connected near the vertex of the radiation element 102 and disposed conically about the common feed point 104. The wires or conductors in the array need not be of the same length in defining the radiation element 102. In the illustrated embodiment, the radiation element 102 is a solid, continuous surface forming the radiation element 102, however FIG. 7 illustrates an alternative radiation element 102 formed from discrete wires or conductors forming a discontinuous array disposed conically about the feed point 104.

In an exemplary embodiment, the monocone antenna 100 includes a substrate 120. The radiation element 102 is provided on one or more surfaces of the substrate 120 while the capacitive ring 110 is provided on one or more other surfaces of the substrate 120. The substrate 120 may substantially fill the capacitive gap 112. The substrate 120 is manufactured from a dielectric material, such as a plastic material, a ceramic material, or another dielectric material. In one particular example, the substrate 120 is a synthetic material such as acrylonitrile butadiene styrene (ABS). Optionally, the substrate 120 may be a layered structure.

The substrate 120 has a top 122 and a bottom 124. The substrate 120 has a cavity 126 defined by an inner cavity wall 128. The cavity 126 may be generally conical in shape defining a concave area inside the substrate 120. In an exemplary embodiment, the radiation element 102 covers at least part of the inner cavity wall 128. The cavity 126 is open at the top 122. The cavity 126 extends vertically into the substrate 120 between the top 122 and the bottom 124. The feed point 104 may be provided at or near the bottom 124.

In an exemplary embodiment, the substrate 120 includes a mounting flange 130 for mounting the monocone antenna 100 to a mounting surface, such as a surface of the aircraft or airframe. The mounting flange 130 includes mounting openings 132 that are configured to receive fasteners (not shown) used to secure the monocone antenna 100 to the mounting surface. Optionally, the mounting flange 130 may be provided at or near the top 122. Alternatively, the mounting flange 130 may be provided remote from the top 122, such as at or near the bottom 124. In an exemplary embodiment, the capacitive ring 110 covers at least a portion of the mounting flange 130.

The substrate 120 includes a base 134, which may be provided at or near the bottom 124. The mounting flange 130 may extend radially outward from the base 134. The base 134 may be provided below the mounting flange 130. The base 134 is configured to be embedded in the mounting structure, such as within the aircraft or airframe. The base 134 has a smaller diameter than the mounting flange 130.

The radiation element 102 extends between a top 140 and a bottom 142. The feed point 104 is provided at the bottom 142. The radiation element 102 is tapered between the top 140 and the bottom 142. The radiation element 102 converges at the vertex at the bottom 142. The diameter of the radiation element 102 is larger at the top 140 than at the bottom 142. The radiation element 102 extends a vertical height between the top 140 and the bottom 142. The vertical height may be less than or equal to a height of the substrate 120.

In an exemplary embodiment, the radiation element 102 is provided directly on the inner cavity wall 128 of the cavity 126 of the substrate 120. For example, the radiation element 102 may be deposited on the inner cavity wall 128. The radiation element 102 may be plated on the inner cavity wall 128. The radiation element 102 may be deposited by other processes in alternative embodiments, such as vapor deposition, chemical deposition, or other coating or layering processes. The radiation element 102 may be a metal layer on the inner cavity wall 128. For example, the radiation element 102 may be a metal layer of copper, aluminum, brass, tin, or another conductive metal material.

The capacitive ring 110 surrounds the radiation element 102. In an exemplary embodiment, the capacitive ring 110 is provided on an exterior of the substrate 120. For example, the capacitive ring 110 may be provided on the top 122, on the bottom 124 and/or on the side wall 136 of the substrate 120. The capacitive ring 110 may be deposited directly on the exterior of the substrate 120. The capacitive ring 110 may be plated on one or more surfaces of the substrate 120. The capacitive ring 110 may be deposited by other processes in alternative embodiments, such as vapor deposition, chemical deposition, or other coating or layering processes. The capacitive ring 110 may be a metal layer on the substrate 120. For example, the capacitive ring 110 may be a metal layer of copper, aluminum, brass, tin, or another conductive metal material. Optionally, the capacitive ring 110 may be embedded in the substrate 120 in addition to, or in lieu of, being deposited on the exterior of the substrate 120.

The capacitive ring 110 extends between a top 150 and a bottom 152. The top 150 may extend along the top 122 of the substrate 120. The bottom 152 may extend along the bottom 124 of the substrate 120. Optionally, the top 150 may be generally co-planar with the top 140 of the radiation element 102. The bottom 152 may be generally co-planar with the bottom 142 of the radiation element 102. In the illustrated embodiment, the capacitive ring 110 is deposited directly on the bottom 124, the side wall 136 and the top 122 of the substrate 120.

The substrate 120 has an exposed surface 154 (FIG. 1) at the top 122 between the top 150 of the capacitive ring and the top 140 of the radiation element 102. The exposed surface 154 may have any shape. In the illustrated embodiment, the exposed surface 154 is ring shaped. A width 156 of the exposed surface 154 defines a spacing between the top 150 of a capacitive ring 110 and the top 140 of the radiation element 102. The spacing controls the capacitance between the radiation element 102 and the capacitive ring 110 for matching the impedance of the monocone antenna 100. In an exemplary embodiment, the substrate 120 has an exposed surface 158 (FIG. 3) at the bottom 124 of the substrate 120. The exposed surface 158 isolates the radiation element 102 from the capacitive ring 110 to control a capacitance therebetween.

In an exemplary embodiment, the mounting flange 130 includes an upper surface 160, a lower surface 162 and a side surface 164 between the upper and lower surfaces 160, 162 around the perimeter edge of the mounting flange 130. The upper surface 160 may define a portion of the top 122 of the substrate 120. The lower surface 162 and/or side surface 164 may define a portion of the side wall 136 of the substrate 120. In an exemplary embodiment, the capacitive ring 110 is provided on the upper surface 160, the lower surface 162 and the side surface 164, however the capacitive ring 110 may be provided on less than all of the surfaces of the mounting flange 130 in alternative embodiments.

In an exemplary embodiment, the base 134 includes a side surface 170 and a lower surface 172. The side surface 170 may extend vertically below the mounting flange 130 to the lower surface 172. The side surface 170 may define at least a portion of the side wall 136 of the substrate 120. The lower surface 172 may define at least a portion of the bottom 124 of the substrate 120. In an exemplary embodiment, the capacitive ring 110 may be provided on the side surface 170 and the lower surface 172, however the capacitive ring 110 may be provided on less than all of the surfaces of the base 134 in alternative embodiments.

Optionally, the side surface 170 may be generally perpendicular to the lower surface 172. For example the lower surface 172 may extend horizontally and the side surface 170 may extend vertically. Alternatively, the side surface 170 may extend transverse to the lower surface 172. For example, the side surface 170 may be angled relative to the lower surface 172. Optionally, the side surface 170 may be angled parallel to the inner cavity wall 128.

In an exemplary embodiment, the capacitive ring 110 is a continuous conductive surface or layer on the lower surface 172 of the base 134, the side surface 170 of the base 134, the lower surface 162 of the mounting flange 130, the side surface 164 of the mounting flange 130 and the upper surface 160 of the mounting flange 130, while the radiation element 102 is a continuous conductive surface or layer on the inner cavity wall 128. The substrate 120 substantially fills the capacitive gap 112 between the radiation element 102 and the capacitive ring 110. The shape of the capacitive gap 112 and the material filling the capacitive gap 112 affect the capacitance for impedance matching between the radiation element 102 and the capacitive ring 110. In an exemplar embodiment, a width of the substrate 120 between the radiation element 102 and the capacitive ring 110 is variable along the height of the substrate 120 between the top 122 and the bottom 124 of the substrate 120. For example, the spacing between the radiation element 102 and the capacitive ring 110 along the mounting flange 130 may be different than the spacing between radiation element 102 and the capacitive ring 110 along the base 134. Additionally, the spacing between the radiation element 102 along the inner cavity wall 128 and the side surface 164 of the mounting flange 130 may vary at different vertical positions (e.g., the spacing increases at lower vertical positions because the inner cavity wall 128 is angled inward). Additionally, the spacing between the radiation element 102 along the inner cavity wall 128 and the side surface 170 of the base 134 may vary at different vertical positions (e.g., the spacing increases at lower vertical positions because the inner cavity wall 128 is angled inward).

FIG. 4 is a top perspective view of the monocone antenna 100 with a cover or radome 180 attached to the top 122 of the substrate 120. FIG. 5 is a side view of the monocone antenna 100 and radome 180. The radome 180 may define an exterior of the monocone antenna 100 and may be generally flush with an exterior surface of the aircraft or airframe. The radome 180 includes mounting openings 182, which may be aligned with the mounting openings 182 of the monocone antenna 100. Fasteners may pass through the radome 180 and the monocone antenna 100 to secure the monocone antenna 100 to the aircraft or airframe. The radome 180 may have a slight convex curvature.

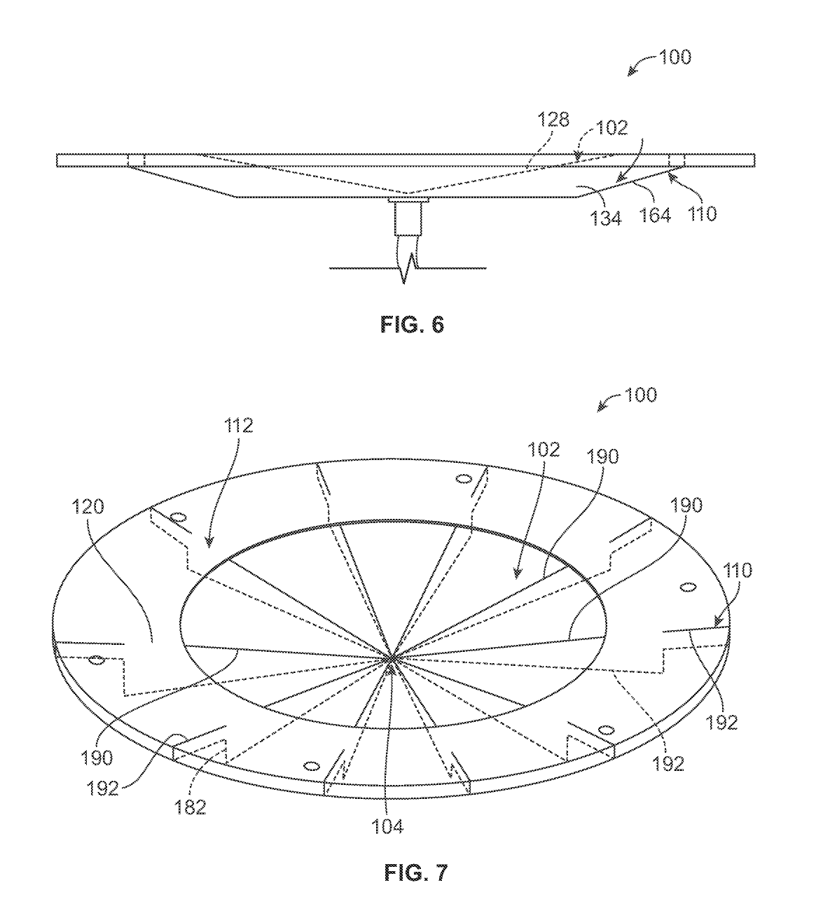

FIG. 6 is a side view of the monocone antenna 100 showing the base 134 with a different shape. The base 134 includes an angled side surface 164, which may be generally parallel to the inner cavity wall 128. As such, the capacitive ring 110 on the angled side surface 164 may extend generally parallel to the radiation element 102. The spacing between the capacitive ring 110 and the radiation element 102 is different in the embodiment shown in FIG. 6 than the embodiment shown in FIG. 2. The capacitance may be greater in the embodiment shown in FIG. 6 than the embodiment shown in FIG. 2.

FIG. 7 is a top perspective view of the monocone antenna 100 with the radiation element 102 formed from discrete wires or conductors 190 forming a discontinuous array disposed conically about the feed point 104. The capacitive ring 110 is also formed from discrete wires or conductors 192 forming a discontinuous array disposed radially outside of the radiation element 102. The substrate 120 supports the wires or conductors 190 and 192. The wires or conductors 190, 192 may be affixed to the substrate. Air may partially or substantially fill the capacitive gap 112 between the capacitive ring 110 and the radiation element 102.

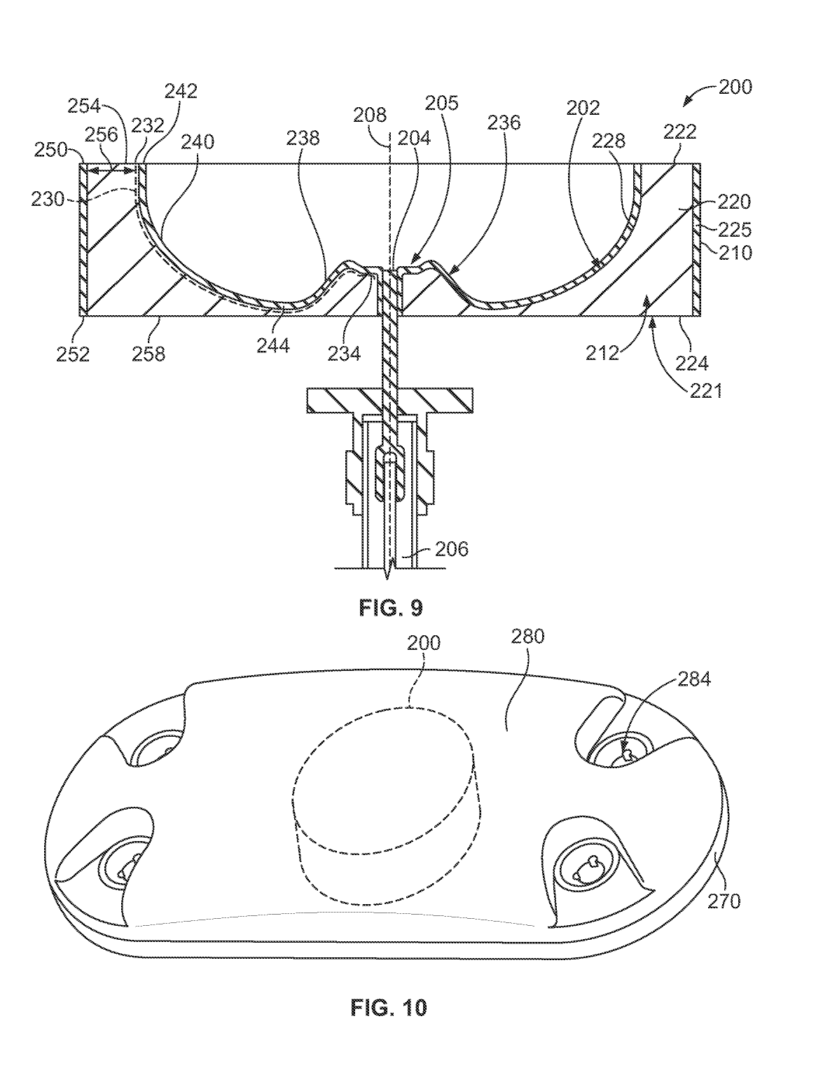

FIG. 8 is a top perspective view of a monocone antenna 200 formed in accordance with an exemplary embodiment. FIG. 9 is a cross-sectional view of the monocone antenna 200. The monocone antenna 200 is similar to the monocone antenna 100 (shown in FIGS. 1-3). The monocone antenna 200 has a different shape, but operates in a similar manner.

The monocone antenna 200 may be either a radiator or receiver of electromagnetic signals, such as radio frequency (RF) signals. In an exemplary embodiment, the monocone antenna 200 is a conformal antenna for installation on an airborne platform, such as a commercial, military, or general aviation platform, on a marine platform or on another vehicular platform; however the monocone antenna 200 is not limited to use in vehicular applications. The conformal antenna 200 may be used as a communication antenna and/or an identification antenna for an airborne vehicle. The monocone antenna 200 has a very low profile to reduce or eliminate aerodynamic drag and potential for damage. Optionally, the monocone antenna 200 may be embedded in a surface of the aircraft such that the monocone antenna 200 has little or no protrusion from the airframe. The monocone antenna 200 is designed to be electrically short to increase its conformity. For example, the monocone antenna 200 may be designed to be less than one-quarter wavelength in height. In an exemplary embodiment, the monocone antenna 200 is less than one-tenth of a free space wavelength in height.

The monocone antenna 200 includes components that provide conjugate reactance to counter the increased reactive effect of being electrically short. For example, the monocone antenna 200 includes capacitive components to add capacitance to the impedance match of the monocone antenna 200 to provide conjugate reactance due to the added inductance due to being electrically short.

The monocone antenna 200 includes a volumetric radiation element 202 that defines a radiator of the monocone antenna 200. The volumetric radiation element 202 is non-planar and thus defines a volume. The volumetric radiation element 202 may be concave, may be convex, may have a flat, non-planar shape, such as a conical shape, or may have any other volumetric shape. The volumetric radiation element 202 has a feed point 204 at a vertex 205 of the volumetric radiation element 202. The feed point 204 is configured to be connected to a feed transmission line 206 (shown in FIG. 9), which may be a cable or other type of feed transmission line. The feed point 204 may be an RF connector, such as a sub-miniature type A (SMA) connector.

The vertex 205 is the base or converging area of the volumetric radiation element 202. The vertex 205 may be the lowest or bottom-most point of the volumetric radiation element 202 (such as with the volumetric radiation element 102 shown in FIG. 2). The vertex 205 may be slightly elevated, such as on a nested protrusion within the monocone antenna 200. The vertex 205 may be a point or may be an area around a point. The vertex 205 may be the attachment point for the feed point 204. Optionally, the vertex 205 may be approximately centered within the monocone antenna 200. Alternatively, the vertex 205 may be offset from a center point of the monocone antenna 200. In an exemplary embodiment, the volumetric radiation element 202 is a surface defined by a spline of rotation that is rotated about an axis 208 (such as a vertical axis) and the vertex 105 may be at the intersection between the spline of rotation and the rotation axis 208.

The monocone antenna 200 includes a tuning ring 210 radially outside of the volumetric radiation element 202 and in proximity to the volumetric radiation element 202. The tuning ring 210 provides impedance matching and provides conjugate reactance for the impedance of the monocone antenna 200. For example, the volumetric radiation element 202 may have increased inductance due to the monocone antenna 200 being electrically short. The tuning ring 210 adds capacitance for impedance matching, and thus defines a capacitive ring, which may be referred to hereinafter as a capacitive ring 210; however in some embodiments, the tuning ring 210 may be designed to add inductance or other tuning to the monocone antenna 200.

The capacitive ring 210 is configured to be connected to a ground plane for the monocone antenna 200. The capacitive ring 210 adds capacitance to the monocone antenna 200 and lowers inductance of the volumetric radiation element 202. The volumetric radiation element 202 is electrically shortened, such as to a height less than one-quarter wavelength, to increase its conformity. Optionally, the volumetric radiation element 202 may be less than one-tenth of a free space wavelength in height. The capacitive ring 210 mitigates the added inductance due to the electrically short volumetric radiation element 202. The monocone antenna 200 is a very short, vertically polarized antenna which may be installed on an aircraft surface or recessed into the aircraft surface to reduce aerodynamic drag and potential for damage by limiting protrusion or height above the aircraft surface.

A capacitive gap 212 is defined between the volumetric radiation element 202 and the capacitive ring 210. The capacitive gap 212 may be at least partially filled with dielectric material, such as a plastic material. The dielectric material may be air. The capacitive gap 212 may be at least partially filled with magnetic material. The size and shape of the capacitive gap 212 controls the spacing between the volumetric radiation element 202 and the capacitive ring 210. The size of the capacitive gap 212 is designed for impedance matching. The spacing between the volumetric radiation element 202 and the capacitive ring 210 controls the added capacitance therebetween for impedance matching.

The monocone antenna 200 may be constructed of one or more conductors defining the volumetric radiation element 202. The conductor or conductors forming the volumetric radiation element 202 may be solid or may be partially solid, such as an array of conductors disposed about the common feed point 204. The conductor or conductors forming the volumetric radiation element 202 may be a surface or may be a wire grid, such as one or more wires connected near the vertex 205 of the volumetric radiation element 202 and disposed about the common feed point 204 (see, for example, FIG. 7). The wires or conductors define a discontinuous, volumetric shape of the monocone antenna 200. The wires or conductors in the array need not be of the same length or the same shape in defining the volumetric radiation element 202. The wires or conductors define splines extending between the feed point 204 and an outer end of the volumetric radiation element 202, such splines may have any shape, including a linear shape, a curved shape, a parabolic shape, a wavy shape, and the like. In the illustrated embodiment, the volumetric radiation element 202 is a solid, continuous surface forming a concave volumetric radiation element 202.

In an exemplary embodiment, with particular reference to FIG. 9, the monocone antenna 200 includes a substrate 220. The volumetric radiation element 202 is provided on one or more surfaces of the substrate 220 while the capacitive ring 210 is provided on one or more other surfaces of the substrate 220. However, in other various embodiments, the volumetric radiation element 202 and/or the capacitive ring 210 may be embedded in the substrate 220. The substrate 220 may substantially fill the capacitive gap 212. In an exemplary embodiment, the substrate 220 is manufactured from a dielectric material, such as a plastic material, a ceramic material, or another dielectric material. In one particular example, the substrate 220 is a synthetic material such as acrylonitrile butadiene styrene (ABS). Optionally, the substrate 220 may be a layered structure. The substrate 220 may be manufactured, at least in part, from a magnetic material.

The substrate 220 has an exterior 221 defined, at least in part, by a top 222, a bottom 224 and a side wall 225 extending between the top 222 and the bottom 224. Optionally, the substrate 220 may include a flange (similar to the flange 130 shown in FIGS. 1-2) extending from the side wall 225. The feed point 204 may be provided at or near the bottom 224. The substrate 220 has a cavity 226 defined by an inner cavity wall 228. In an exemplary embodiment, the volumetric radiation element 202 covers at least part of the inner cavity wall 228. In an exemplary embodiment, the cavity 226 is open at the top 222; however the cavity 226 may be closed and/or at least partially filled with material, such as the same material as the substrate 220. The cavity 226 extends vertically into the substrate 220 between the top 222 and the bottom 224. The cavity 226 forms a volume depressed below the top 222. The cavity 226 may be generally conical in shape. For example, the conical nature of the cavity 226 has a generally wider top 222 and a generally narrower bottom 224. The conical nature of the cavity 226 is defined by the generally inward taper of the cavity 226.

The inner cavity wall 228 is defined by a spline of revolution. The spline of revolution is a three-dimensional surface defined by rotating a spline 230 about the feed point 204 (or other axis of rotation). The spline 230 extends from the top 222 to the vertex 205, such as at the feed point 204. The spline 230 may have any shape to form any shaped cavity 226. The shape of the inner cavity wall 228, and thus the volumetric radiation element 202, affects the antenna characteristics of the monocone antenna 200. For example, the shape of the inner cavity wall 228 may affect the frequency ranges of operation of the monocone antenna 200, the bandwidth of the monocone antenna 200, the polarization of the monocone antenna 200, the impedance of the monocone antenna 200, and the like.

The spline 230 is an imaginary line or numeric function, which may be a single polynomial function or a series of piecewise polynomial functions. The spline 230 may have smooth transitions at the places where the polynomial pieces connect. The spline 230 extends between an outer end 232 at the top 222 and an inner end 234, which may be at the vertex 205, such as at the feed point 204. As noted above, the spline 230 may be linear between the outer end 232 at the top 222 and the vertex 205 at or near the bottom 224. The spline 230 has an inward angle such that the spline is non-coplanar with the top 222, but rather is angled downward. The surface or spline of revolution formed by such a linear spline may form the inner cavity wall 228 having a right circular conical shape. The inner cavity wall 228 may have an oblique conical shape in other embodiments, such as where the vertex 205 is non-centered within the cavity 226 and/or where the vertex 205 is offset from the rotation axis 208. Optionally, the inner cavity wall 228 may have an elliptic conical shape (e.g., tapering oval) in various embodiments, such as where the vertex 205 is offset from the rotation axis 208.

In other various embodiments, such as the embodiment shown in FIGS. 8-9, the spline 230 may be curved between the top 222 and the vertex 205. For example, the inner cavity wall 228 may have a parabolic shape, an elliptic parabolic shape, and the like. Optionally, the curved spline 230 may have different radius of curvature along different segments. For example, the spline 230 may have a steep slope at or near the outer end 232 and a shallow slope at or near the inner end 234. Alternatively, the spline 230 may have a shallow slope at or near the outer end 232 and a steep slope at or near the inner end 234. In other various embodiments, the spline 230 may have a steep slope at or near the outer end 232, a shallow slope at a middle segment, and a steep slope at or near the inner end 234. Optionally, the curved spline 230 may have negative slope and/or positive slope along different segments. Optionally, the curved spline 230 may have a volumetric shape and/or a convex shape along different segments.

In the illustrated embodiment, the spline 230 has a parabolic shape having a steep, negative slope at the outer end 232. The spline 230 is curved and tapers to a shallower shape as the spline approaches the vertex 205. The spline 230 has an upward slope near the vertex 205 and may approximately level off at the vertex 205. The surface of the inner cavity wall 228, and thus the volumetric radiation element 202, formed by the spline of revolution forms a nested protrusion 236 in the cavity 226. The nested protrusion 236 is located at the vertex 205. The nested protrusion 236 is elevated or protrudes upward slightly into the cavity 226. The nested protrusion may have any size or shape. In an exemplary embodiment, the nested protrusion 236 remains below the top 222 of the substrate 220 such that a portion of the cavity 226 is located above the nested protrusion 236.

The nested protrusion 236 has a slope surface 238 that faces an outer slope surface 240 of the volumetric radiation element 202, which is radially outward of the nested protrusion 236. The nested protrusion 236 affects the antenna characteristics of the monocone antenna 200, as compared to a volumetric radiation element having only a downward slope to the vertex (e.g., a right circular cone). For example, the nested protrusion 236 may affect the frequency ranges of operation of the monocone antenna 200, the bandwidth of the monocone antenna 200, the polarization of the monocone antenna 200, the impedance of the monocone antenna 200, and the like. The nested protrusion 236 may increase the bandwidth or frequency range and/or allow a smaller overall monocone antenna to achieve similar bandwidth or frequency range as an antenna that does not include the nested protrusion 236. Having a smaller monocone antenna 200 provides better conformity of the monocone antenna 200 with the vehicle or aircraft, reducing aerodynamic drag and/or the risk of damage.

The volumetric radiation element 202 extends between a top 242 and a bottom 244. The top 242 may be provided at or near the top 222 of the substrate 220. The bottom 244 may be provided near the bottom 224. For example, a thin layer of the substrate 220 may be provided below the bottom 244. The nested protrusion 236 may extend upward from the bottom 244 such that the portion of the volumetric radiation element 202 on the nested protrusion 236 is elevated above the bottom 244. In other various embodiments, the monocone antenna 200 may be devoid of the nested protrusion 236 and the vertex 205 may be provided at the bottom 244 rather than at the nested protrusion 236. The outer slope surface 240 of the volumetric radiation element 202 is generally tapered between the top 242 and the bottom 244, and may be tapered along a curved path, as in the illustrated embodiment, or along a linear path, as in the embodiment illustrated in FIGS. 1-2. The volumetric radiation element 202 generally converges to the vertex 205. The diameter of the volumetric radiation element 202 is larger at the top 242 than at the bottom 244. In an exemplary embodiment, the outer slope surface 240 may be steep such that the volumetric radiation element 202 has a relatively large diameter even at or near the bottom 244 as compared to a more shallow tapered radiation element 202, such as the radiation element 102 (shown in FIGS. 1-2). The volumetric radiation element 202 extends a vertical height between the top 242 and the bottom 244. The vertical height may be less than or equal to a height of the substrate 220.

In an exemplary embodiment, the volumetric radiation element 202 is provided directly on the inner cavity wall 228 of the cavity 226 of the substrate 220. For example, the volumetric radiation element 202 may be deposited on the inner cavity wall 228. The volumetric radiation element 202 may be plated on the inner cavity wall 228. The volumetric radiation element 202 may be deposited by other processes in alternative embodiments, such as vapor deposition, chemical deposition, or other coating or layering processes. The volumetric radiation element 202 may be a metal layer on the inner cavity wall 228. For example, the volumetric radiation element 202 may be a metal layer of copper, aluminum, brass, tin, or another conductive metal material.

The capacitive ring 210 surrounds the volumetric radiation element 202. In an exemplary embodiment, the capacitive ring 210 is provided on the exterior 221 of the substrate 220. For example, the capacitive ring 210 may be provided on the top 222, on the bottom 224 and/or on the side wall 225 of the substrate 220. The capacitive ring 210 may be deposited directly on the exterior 221 of the substrate 220. The capacitive ring 210 may be plated on one or more surfaces of the substrate 220. The capacitive ring 210 may be deposited by other processes in alternative embodiments, such as vapor deposition, chemical deposition, or other coating or layering processes. The capacitive ring 210 may be a metal layer on the substrate 220. For example, the capacitive ring 210 may be a metal layer of copper, aluminum, brass, tin, or another conductive metal material. Optionally, the capacitive ring 210 may be embedded in the substrate 220 in addition to, or in lieu of, being deposited on the exterior of the substrate 220. In other various embodiments, the capacitive ring 210 may be a pre-formed capacitive structure, such as a molded or die cast metal structure, having an opening or chamber that receives the substrate 220. The metal structure holds the substrate 220 therein.

The capacitive ring 210 extends between a top 250 and a bottom 252. The top 250 may extend along the top 222 of the substrate 220 or may extend along the side wall 225 to the edge at the top 222. The bottom 252 may extend along the bottom 224 of the substrate 220 or may extend along the side wall 225 to the edge at the bottom 252. Optionally, the top 250 may be generally co-planar with the top 242 of the volumetric radiation element 202. The bottom 252 may be generally co-planar with the bottom 244 of the volumetric radiation element 202. In the illustrated embodiment, the capacitive ring 210 is provided only along the side wall 225; however the capacitive ring 210 may be additionally be on the top 250 and/or the bottom 252 in alternative embodiments. The capacitive ring 210 may have any shape designed to surround the volumetric radiation element 202, and is not limited to a circular shape.

The substrate 220 has an exposed surface 254 (FIG. 2) at the top 222 between the top 250 of the capacitive ring and the top 242 of the volumetric radiation element 202. The exposed surface 254 may have any shape. In the illustrated embodiment, the exposed surface 254 is ring shaped. A width 256 of the exposed surface 254 defines a spacing between the top 250 of a capacitive ring 210 and the top 242 of the volumetric radiation element 202. The spacing controls the capacitance between the volumetric radiation element 202 and the capacitive ring 210 for matching the impedance of the monocone antenna 200. In an exemplary embodiment, the substrate 220 has an exposed surface 258 (FIG. 3) at the bottom 224 of the substrate 220. The exposed surface 258 isolates the volumetric radiation element 202 from the capacitive ring 210 to control a capacitance therebetween.

Optionally, the side wall 225 may be generally perpendicular to the top 222 and/or the bottom 224. For example the top 222 and/or the bottom 224 may extend horizontally and the side wall 225 may extend vertically. Alternatively, the side wall 225 may extend transverse to the top 222 and/or the bottom 224. The side wall 225 may be linear, or alternatively, may be curved. Optionally, the side wall 225 may follow the general angle/curve of the inner cavity wall 228 such that the side wall 225 may be approximately equidistant from the inner cavity wall 228, and thus the capacitive ring 210 is equidistant (e.g., constant width of the capacitive gap 212) from the volumetric radiation element 202.

In an exemplary embodiment, the capacitive ring 210 is a continuous conductive surface or layer on the substrate 220, while the volumetric radiation element 202 is a continuous conductive surface or layer on the inner cavity wall 228. The substrate 220 substantially fills the capacitive gap 212 between the volumetric radiation element 202 and the capacitive ring 210. The shape of the capacitive gap 212 and the material filling the capacitive gap 212 affect the capacitance for impedance matching between the volumetric radiation element 202 and the capacitive ring 210. In an exemplar embodiment, a width of the substrate 220 between the volumetric radiation element 202 and the capacitive ring 210 is variable along the height of the substrate 220 between the top 222 and the bottom 224 of the substrate 220. For example, the capacitive ring 210 on the side wall 225 may be vertical while the volumetric radiation element 202 on the inner cavity wall 228 is tapered inward.

In FIG. 8, the monocone antenna 200 is illustrated seated in a base mount 270. For example, the monocone antenna 200 is seated in a pocket 272 in the base mount 270, which supports and holds the monocone antenna 200. The base mount 270 is configured to be mounted to the vehicle or aircraft. In an exemplary embodiment, the base mount 270 includes a gasket or seal 274 in a groove around the perimeter of the base mount 270, which is used to seal to a radome 280 (shown in FIG. 10).

FIG. 10 is a top perspective view of the monocone antenna 200 with the cover or radome 280 attached to the base mount 270. The radome 280 may define an exterior shell and may be generally flush with an exterior surface of the vehicle or aircraft. The radome 280 includes mounting openings 284, which may be aligned with corresponding mounting openings of the base mount 270. Fasteners may pass through the radome 280 and the base mount 270 to secure the monocone antenna 200 to the aircraft or airframe. The radome 280 may have a slight convex curvature.

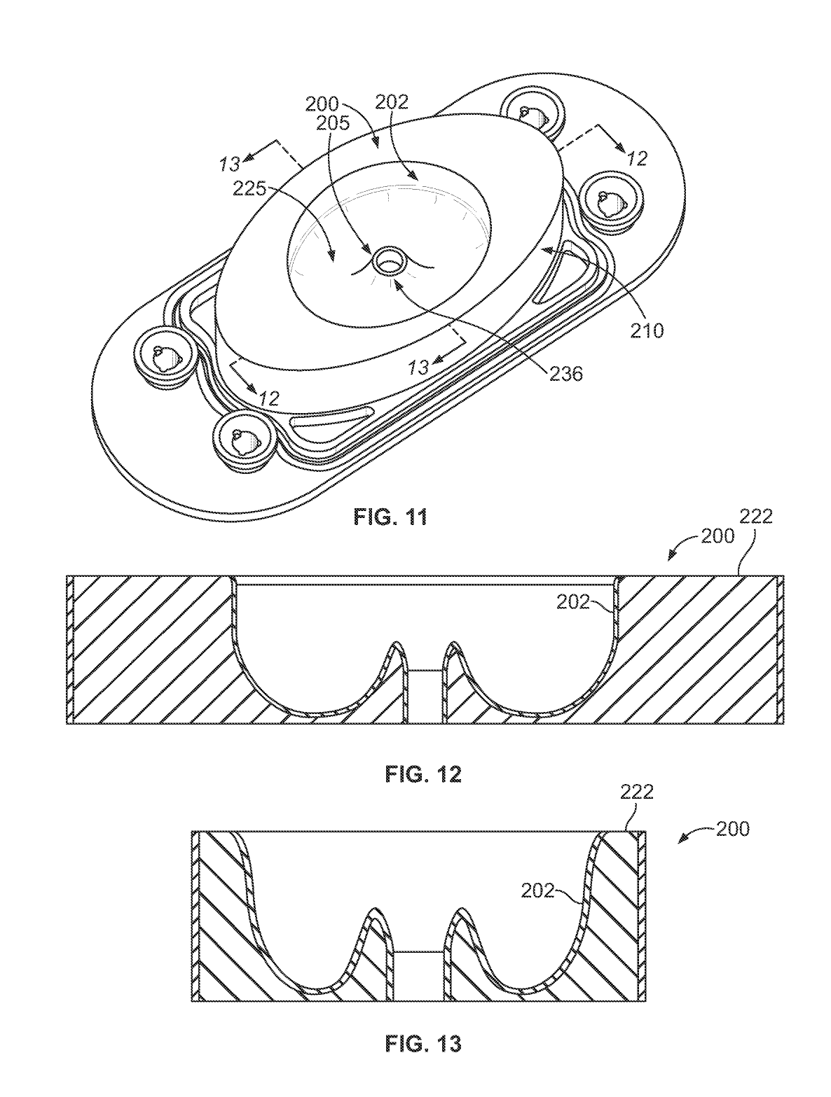

FIG. 11 is a top perspective view of the monocone antenna 200 formed in accordance with an exemplary embodiment. The monocone antenna 200 shown in FIG. 11 has a different shape than the embodiment shown in FIG. 8. The monocone antenna 200 has a generally oval or elliptical shape, as opposed to the circular shape shown in FIG. 8. The shape of the monocone antenna 200, and thus the shape of the volumetric radiation element 202 and the capacitive ring 210, affects the antenna characteristics of the monocone antenna 200. For example, the shape may affect the frequency ranges of operation of the monocone antenna 200, the bandwidth of the monocone antenna 200, the polarization of the monocone antenna 200, the impedance of the monocone antenna 200, and the like. Having the volumetric radiation element 202 larger in one direction may increase the bandwidth and/or the frequency ranges of the monocone antenna as compared to a circular monocone antenna having a diameter equal to the width of the minor axis. Having the volumetric radiation element 202 smaller in one direction may decrease the aerodynamic drag of the monocone antenna structure (e.g., the radome), such as when the major axis is oriented parallel to the wind direction, as compared to a circular monocone antenna having a diameter equal to the width of the major axis.

The cavity 226 and the volumetric radiation element 202 in the cavity 226 also have a different shape than the embodiment shown in FIG. 8. For example, the cavity 226 and the volumetric radiation element 202 have an elliptical shape, with the vertex 205 and nested protrusion 236 approximately centered at the bottom of the cavity 226. In an exemplary embodiment, the nested protrusion 236 is also elliptical shaped.

FIG. 12 is a cross-sectional view of the monocone antenna 200 shown in FIG. 11 taken along the major axis of the monocone antenna 200. FIG. 13 is a cross-sectional view of the monocone antenna 200 shown in FIG. 11 taken along the minor axis of the monocone antenna 200. The width of the volumetric radiation element 202 at the top 222 is wider along the major axis than along the minor axis.

Aspects of the monocone antenna 200 (shown in FIGS. 8-12) may be applicable to the monocone antennas 100 (shown in FIGS. 1-6 or FIG. 7), and vice versa. For example, sizes, shapes, spacings and the like of the volumetric radiation element 202 and/or the capacitive ring 210 may be used in the various embodiments to provide a conformal communication antenna or identification antenna, which may be adapted for use in vehicles or other applications. The monocone antennas may be vertically polarized to efficiently transmit and/or receive vertically polarized signals. The monocone antennas may be sized to reduce aerodynamic drag and risk of damage. The monocone antennas may be designed for wideband operation and have shapes that provide good impedance match across a wide frequency range. The capacitive ring is sized/shaped/positioned to counter the increased reactive effect (e.g., being inductive) of being electrically short and provide conjugate reactance.

As used herein, an element or step recited in the singular and proceeded with the word “a” or “an” should be understood as not excluding plural of said elements or steps, unless such exclusion is explicitly stated. Furthermore, references to “one embodiment” or “an embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f), unless and until such claim limitations expressly use the phrase “means for” followed by a statement of function void of further structure.

What is claimed is:

1. A monocone antenna comprising:
a volumetric radiation element having a feed point at a vertex of the volumetric radiation element being connected to a feed transmission line; and
a capacitive ring radially outside of the volumetric radiation element and in proximity to the volumetric radiation element, the capacitive ring being connected to a ground plane for the monocone antenna.

2. The monocone antenna of claim 1, further comprising a capacitive gap between the volumetric radiation element and the capacitive ring, the capacitive gap being substantially filled with dielectric material.

3. The monocone antenna of claim 1, wherein the volumetric radiation element extends vertically between an open top and the vertex of the volumetric radiation element, the capacitive ring extends vertically from a top to a bottom, the top of the capacitive ring being generally coplanar with the top of the volumetric radiation element, the bottom of the capacitive ring being vertically aligned with or vertically below the vertex.

4. The monocone antenna of claim 1, further comprising a substrate having an inner cavity wall defining a cavity open at a top of the substrate, the volumetric radiation element being located on the inner cavity wall of the substrate, the capacitive ring being positioned radially outside of the inner cavity wall.

5. The monocone antenna of claim 4, wherein the capacitive ring is positioned on an exterior of the substrate.

6. The monocone antenna of claim 5, wherein a width of the substrate between the inner cavity wall and corresponding volumetric radiation element and the exterior and corresponding capacitive ring is variable along a height of the substrate.

7. The monocone antenna of claim 4, wherein the inner cavity wall is defined by a spline of revolution, the spline of revolution being linear between the top and the vertex.

8. The monocone antenna of claim 4, wherein the inner cavity wall is defined by a spline of revolution, the spline of revolution being curved between the top and the vertex.

9. The monocone antenna of claim 4, wherein the inner cavity wall has a right circular conical shape.

10. The monocone antenna of claim 4, wherein the inner cavity wall has an oblique conical shape.

11. The monocone antenna of claim 4, wherein the inner cavity wall has an elliptic conical shape.

12. The monocone antenna of claim 4, wherein the inner cavity wall has an elliptic parabolic shape.

13. The monocone antenna of claim 1, further comprising a substrate having a base, a top and a side wall between the base and the top, the substrate having a cavity with the volumetric radiation element positioned in the cavity, the capacitive ring being positioned on the side wall.

14. The monocone antenna of claim 13, wherein the volumetric radiation element is deposited directly on an inner cavity wall of the substrate defining the cavity.

15. The monocone antenna of claim 13, wherein the capacitive ring is positioned on at least one of the top and the base.

16. The monocone antenna of claim 13, wherein the substrate defines a capacitive gap between the capacitive ring and the volumetric radiation element.

17. The monocone antenna of claim 1, wherein the volumetric radiation element includes a nested protrusion at the vertex, the nested protrusion being connected to the feed point.

18. The monocone antenna of claim 17, wherein the volumetric radiation element includes an outer segment radially outward of the nested protrusion, the outer segment being inwardly and downwardly tapered, the nested protrusion being inwardly and upwardly tapered.

19. The monocone antenna of claim 1, wherein the vertex of the volumetric radiation element is the bottom-most area of the volumetric radiation element.

20. The monocone antenna of claim 1, wherein the volumetric radiation element is defined by a spline of revolution, the spline of revolution having a spline extending from a top of the monocone antenna to the vertex, the spline being rotated about the feed point to define the spline of revolution.

21. The monocone antenna of claim 20, wherein the spline is linear.

22. The monocone antenna of claim 20, wherein the spline has at least one downward component at a radially outer side of the spline and at least one upward component radially inside the radially outer side.
